(19) United States
(12) Patent Application Publication
(10) Pub. No.: US 2026/0023356 A1
(43) Pub. Date: Jan. 22, 2026

(54) SIGNAL PROCESSING SYSTEM, CONTROL TARGET DEVICE, AND SIGNAL PROCESSING METHOD

(71) Applicant: Sharp NEC Display Solutions, Ltd., Tokyo (JP)

(72) Inventor: Isamu KENMOCHI, Tokyo (JP)

(21) Appl. No.: 19/343,765

(22) Filed: Sep. 29, 2025

Related U.S. Application Data
(63) Continuation of application No. PCT/JP2024/009355, filed on Mar. 11, 2024.

(30) Foreign Application Priority Data
Apr. 26, 2023 (JP) 2023-072468

(51) Int. Cl. G05B 15/02

(52) U.S. Cl. CPC G05B 15/02

(57) ABSTRACT

A signal processing system includes: a first device to receive a control signal from an external device; a second device connected to the first device and to control a control target device; and a first storage medium connected to the first and second devices. The first device includes a first processor to output the control signal to the second device and a second storage medium connected to the first processor via a first internal communication path. The second device includes a second processor to control the control target device based on the control signal and a third storage medium connected to the second processor via a second internal communication path. The first storage medium is connected to the first and second internal communication pathes. The first storage medium stores the control signal input via the first internal communication path, and outputs the control signal via the second internal communication path.

### TECHNICAL FIELD

The present invention relates to a signal processing system, a control target device, and a signal processing method.

### BACKGROUND ART

In the related art, for example, a multi-processor system described in Patent Document 1 is known as a technique for transmitting signals between a plurality of CPUs. The multi-processor system described in Patent Document 1 transmits data between a CPU-A and a CPU-B via a shared memory. The CPU-A sets a universal input/output terminal to which an output terminal of the CPU-A and an input terminal of the CPU-B are connected to be active at the time of accessing the shared memory such that the CPU-B does not access the shared memory at the same time. The CPU-B sets a universal input/output terminal to which an output terminal of the CPU-B and an input terminal of the CPU-A are connected to be active at the time of accessing the shared memory such that the CPU-A does not access the shared memory at the same time.

### Citation List

### Patent Document

Patent Document 1: Japanese Unexamined Patent Application, First Publication No. 2005-352559

### SUMMARY OF INVENTION

### Technical Problem

However, in the multi-processor system described in Patent Document 1, the CPUs are provided in different devices, and a signal may not be able to be rapidly transmitted when a signal transmitted from an external device is transmitted to a control target device via a plurality of devices and one CPU is using the shared memory.

The present disclosure was invented in consideration of the aforementioned circumstances, and an objective thereof is to provide a signal processing system, a control target device, and a signal processing method that enable rapidly transmission of a signal with respect to the control target device.

### Solution to Problem

The present disclosure was invented to achieve the aforementioned objective, and an aspect of the present disclosure is a signal processing system including: a first device configured to receive a control signal from an external device; a second device connected to the first device and configured to control a control target device; and a first storage medium connected to the first device and the second device, wherein the first device includes a first processor configured to output the control signal to the second device and a second storage medium connected to the first processor via a first internal communication path, and the second device includes a second processor configured to control the control target device on the basis of the control signal and a third storage medium connected to the second processor via a second internal communication path, and wherein the first storage medium is connected to the first internal communication path and the second internal communication path, stores the control signal input via the first internal communication path, and outputs the stored control signal via the second internal communication path.

Another aspect of the present disclosure is a control target device including: a first device configured to receive a control signal from an external device; a second device connected to the first device; a first storage medium connected to the first device and the second device; and an operating unit controlled by the second device, wherein the first device includes a first processor configured to output a control signal to the second device and a second storage medium connected to the first processor via a first internal communication path, and the second device includes a second processor configured to control the operating unit on the basis of the control signal and a third storage medium connected to the second processor via a second internal communication path, and wherein the first storage medium is connected to the first internal communication path and the second internal communication path, stores the control signal input via the first internal communication path, and outputs the stored control signal via the second internal communication path.

Another aspect of the present disclosure is a signal processing method in a signal processing system including: a first device configured to receive a control signal from an external device; a second device connected to the first device and configured to control a control target device; a first storage medium connected to the first device and the second device; and a bidirectional serial communication path configured to enable the first device and the second device to perform bidirectional serial communication. The signal processing method includes: a step of determining whether an amount of information of the control signal is greater than a threshold value; a step of causing a first processor of the first device to output the control signal to the first storage medium via a first internal communication path of the first device when the amount of information of the control signal is greater than the threshold value; a step of causing a second processor of the second device to input the control signal from the first storage medium via a second internal communication path of the second device; and a step of causing the second processor to output the control signal to the control target device.

### Advantageous Effects of Invention

According to an aspect of the present invention, it is possible to enable rapid transmission of a signal with respect to a control target device.

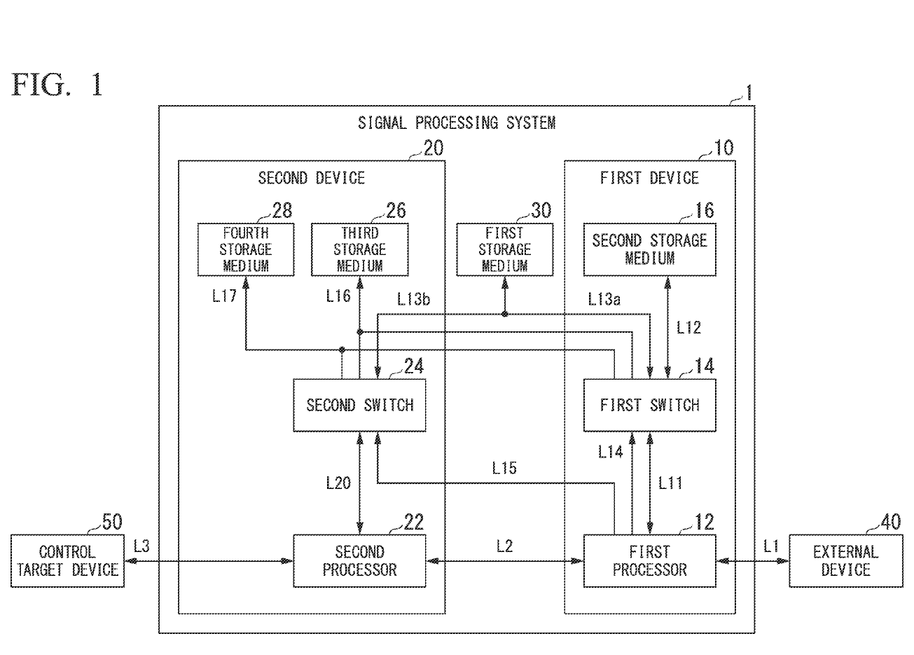

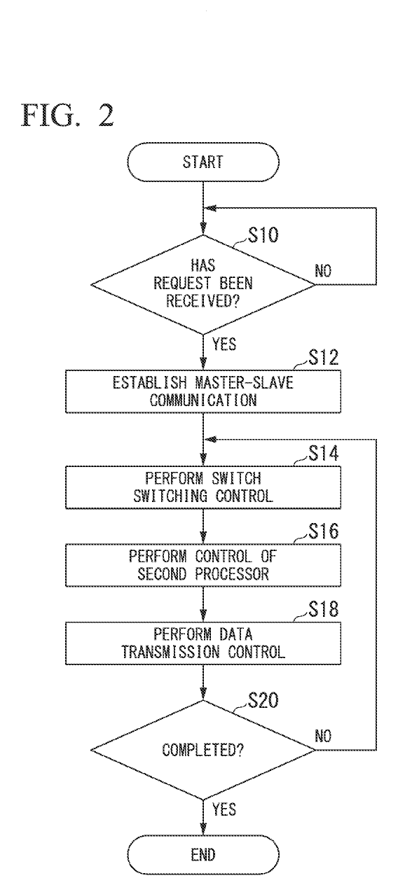

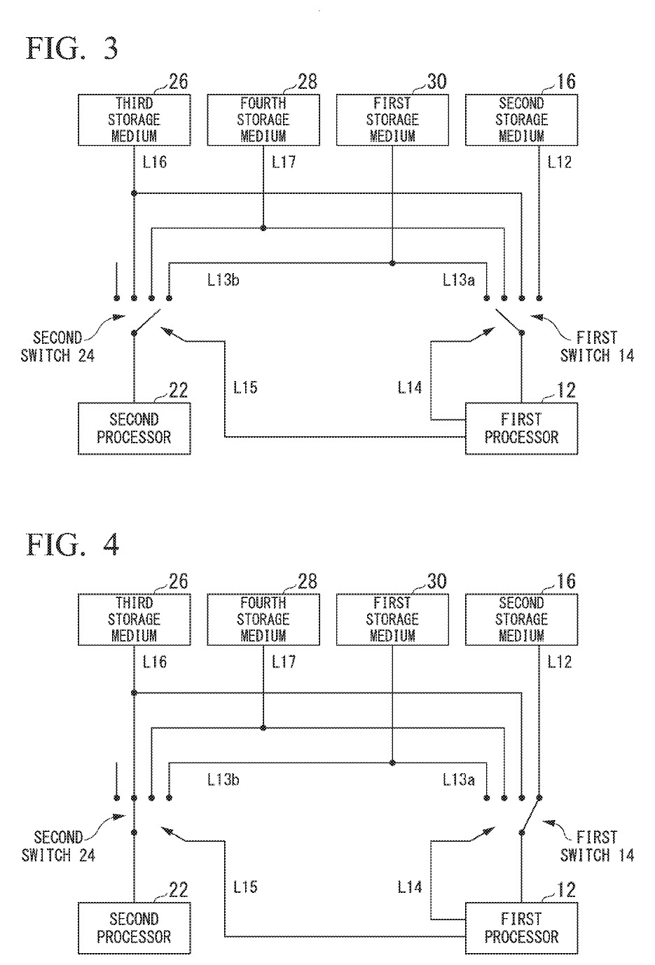

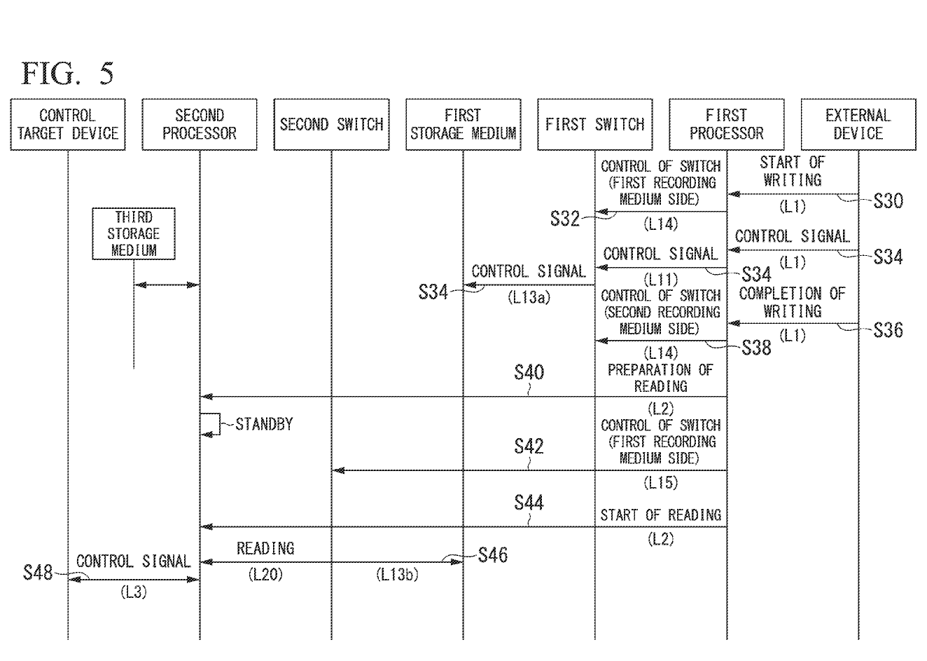

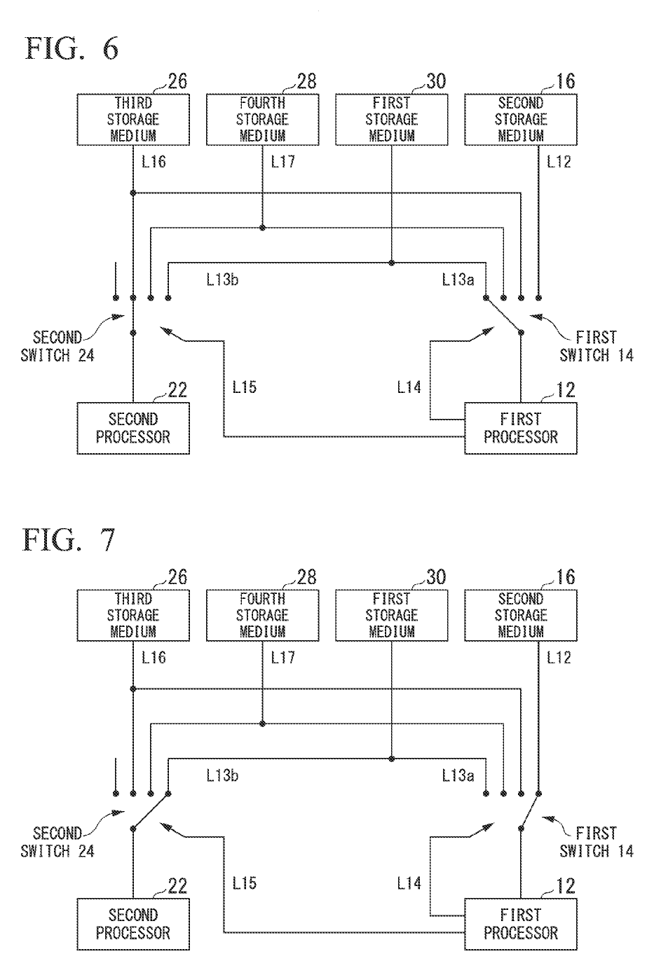

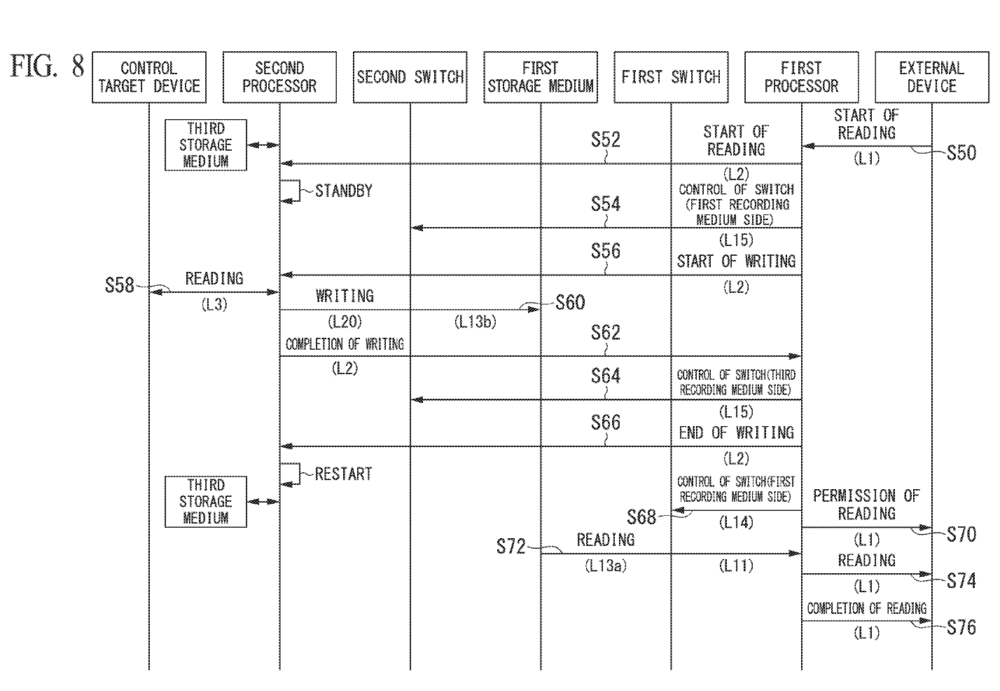

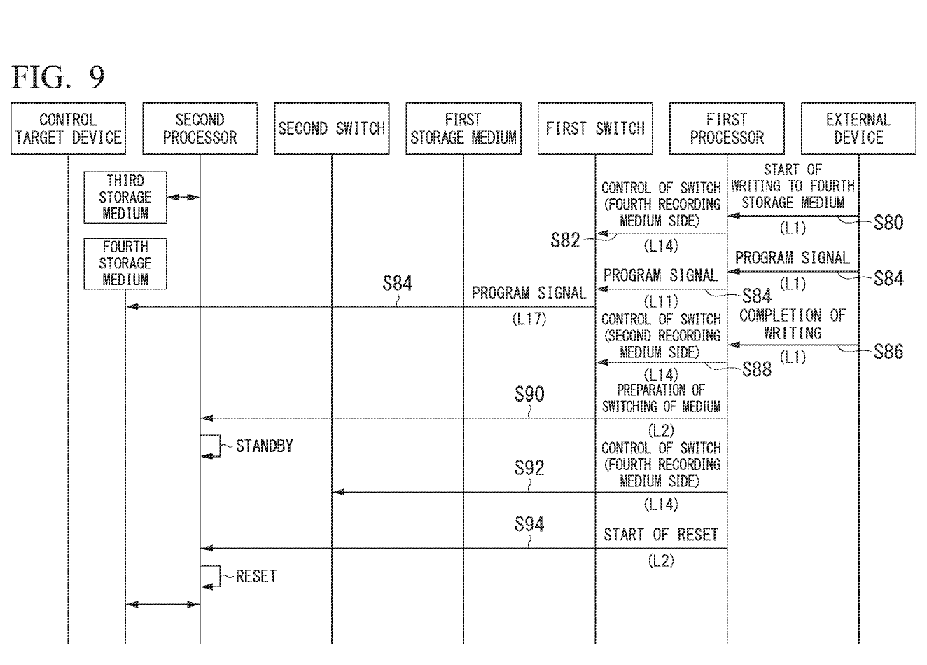

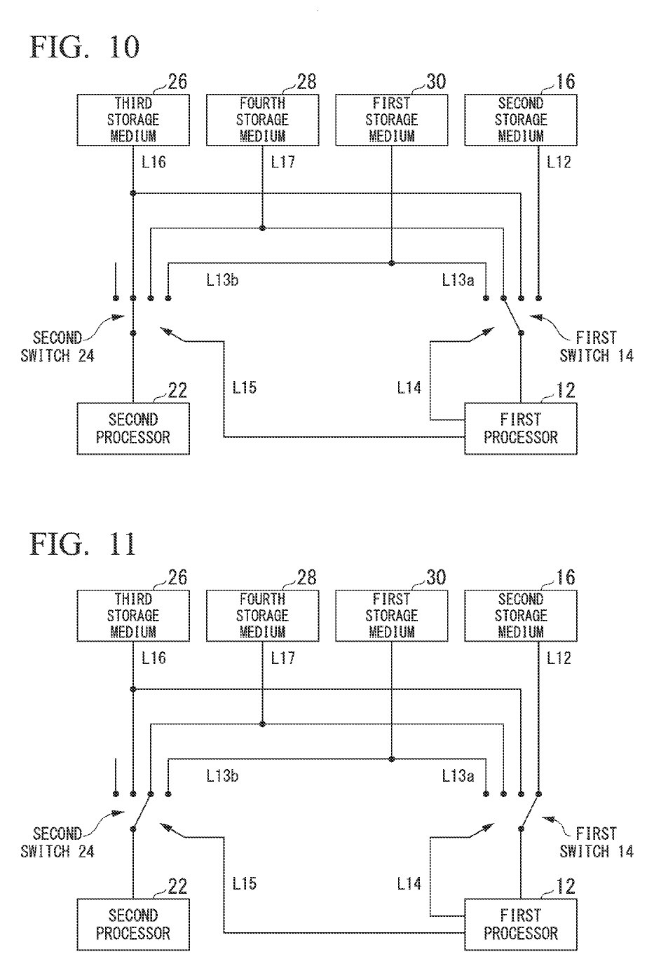

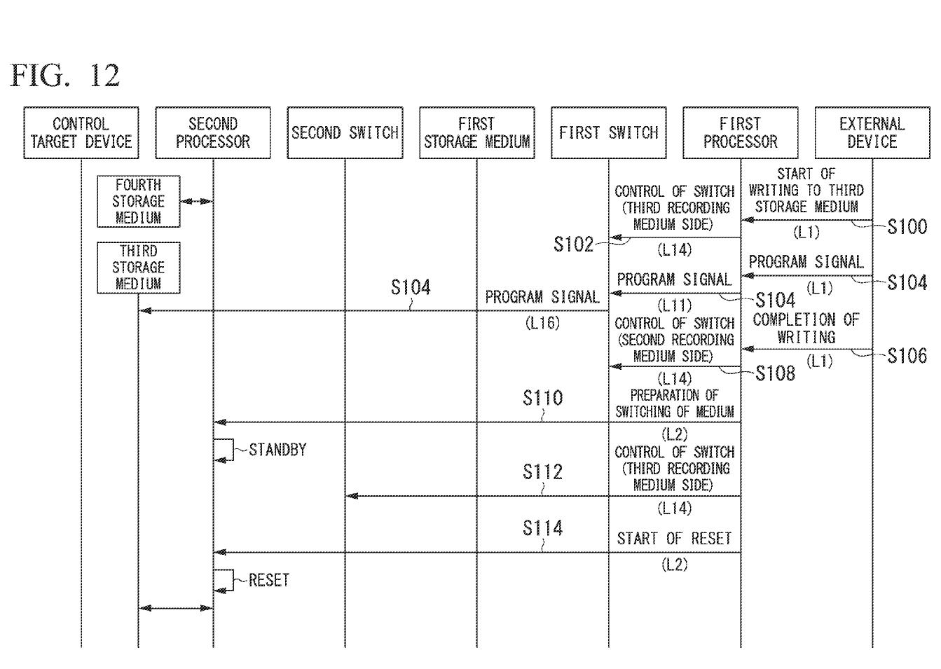

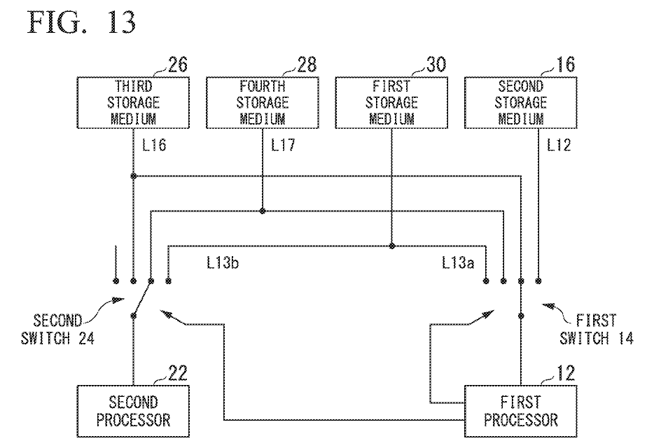

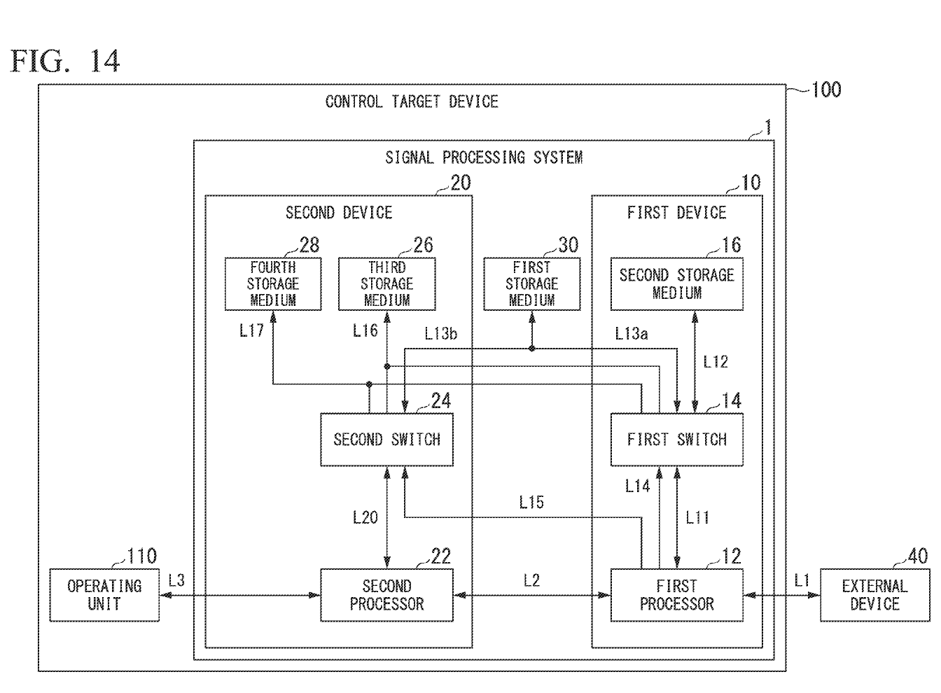

### BRIEF DESCRIPTION OF DRAWINGS

[FIG. 1] A block diagram illustrating an example of a signal processing system according to an embodiment.

[FIG. 2] A flowchart illustrating an example of an operation flow of a first processor according to the embodiment.

[FIG. 3] A diagram illustrating an example of a circuit configuration of the signal processing system according to the embodiment.

[FIG. 4] A diagram illustrating an example of a circuit configuration in which a first switch and a second storage medium are connected in the signal processing system according to the embodiment.

[FIG. 5] A sequence diagram illustrating an example of a process of transmitting a control signal that is performed by the signal processing system according to the embodiment.

[FIG. 6] A diagram illustrating an example of a circuit configuration in which the first switch and a first storage medium are connected in the signal processing system according to the embodiment.

[FIG. 7] A diagram illustrating an example of a circuit configuration in which a second switch and the first storage medium are connected in the signal processing system according to the embodiment.

[FIG. 8] A sequence diagram illustrating an example of a process of causing an external device to read a signal stored in the first storage medium that is performed by the signal processing system according to the embodiment.

[FIG. 9] A sequence diagram illustrating an example of a process of rewriting a program stored in a fourth storage medium that is performed by the signal processing system according to the embodiment.

[FIG. 10] A diagram illustrating an example of a circuit configuration in which the first switch and the fourth storage medium are connected in the signal processing system according to the embodiment.

[FIG. 11] A diagram illustrating an example of a circuit configuration in which the second switch and the fourth storage medium are connected in the signal processing system according to the embodiment.

[FIG. 12] A sequence diagram illustrating an example of a process of rewriting a program stored in a third storage medium that is performed by the signal processing system according to the embodiment.

[FIG. 13] A diagram illustrating an example of a circuit configuration in which the second switch and the fourth storage medium are connected in the signal processing system according to the embodiment.

[FIG. 14] A block diagram illustrating a modified example of the signal processing system according to the embodiment.

### DESCRIPTION OF EMBODIMENTS

Hereinafter, a signal processing system, a control target device, and a signal processing method according to the present invention will be described with reference to the accompanying drawings.

FIG. 1 is a block diagram illustrating an example of a signal processing system 1 according to an embodiment.

The signal processing system 1 includes, for example, a first device 10, a second device 20, and a first storage medium 30. The first device 10 is connected to an external device 40 via a serial communication path L1. The first device 10 and the second device 20 are connected to each other via a bidirectional serial communication path L2. The bidirectional serial communication path L2 is an example of a communication path connecting the first device 10 and the second device 20. The second device 20 is connected to a control target device 50 via a serial communication path L3.

The external device 40 is a device that is separate from the signal processing system 1. The external device 40 is, for example, a personal computer that is used by a user. The control target device 50 is a device that is separate from the signal processing system 1. The control target device 50 is, for example, a display device. The control target device 50 may be a display control device that is incorporated into a display device. The display control device controls display of the display device.

The signal processing system 1 outputs data input from the external device 40 to the control target device 50 via the first device 10 and the second device 20. The data input from the external device 40 is, for example, a control signal for controlling a display state of the display device. The control target device 50 switches the display state on the basis of the control signal. The signal processing system 1 outputs data output from the control target device 50 to the external device 40 via the first device 10 and the second device 20. The data output from the control target device 50 is, for example, information indicating a control state of the display device. The external device 40 can present a video displayed by the display device on the basis of the information indicating the control state of the display device to a user. The first device 10 in the embodiment is connected to the external device 40, but the present invention is not limited thereto and may be connected to another device other than a personal computer, output a signal generated by the first device 10, or output a signal stored in the first device 10.

The first device 10 is an electronic circuit for communicating with the external device 40. The first device 10 includes, for example, a first processor 12, a first switch 14, and a second storage medium 16. The first processor 12 is, for example, a processor such as a central processor (CPU). The first switch 14 is a switch circuit for switching a transmission path of a signal. The second storage medium 16 is, for example, a flash read only memory (ROM). For example, a program with which the first processor 12 operates is stored in the second storage medium 16.

The first processor 12 is connected to the first switch 14 via an internal communication path L11. The first switch 14 and the second storage medium 16 are connected via an internal communication path L12. The internal communication paths L11 and L12 are an example of a first internal communication path and are communication paths for transmitting and receiving a signal through master-slave communication. In the first device 10, the first processor 12 is a master device, and the first switch 14 and the second storage medium 16 are slave devices.

The second device 20 is an electronic circuit for communicating with the control target device 50. The second device 20 is connected to the first device 10 via the bidirectional serial communication path L2 and controls the control target device 50 via the serial communication path L3. The second device 20 includes, for example, a second processor 22, a second switch 24, a third storage medium 26, and a fourth storage medium 28. The second processor 22 is, for example, a processor such as a CPU. The second switch 24 is a switch circuit for switching a transmission path of a signal. The third storage medium 26 is, for example, a flash ROM. The fourth storage medium 28 is, for example, a flash ROM. For example, programs with which the second processor 22 operates are stored in the third storage medium 26 and the fourth storage medium 28.

The first processor 12 and the second processor 22 are connected via the bidirectional serial communication path L2 enabling bidirectional serial communication. The second processor 22 is connected to the second switch 24 via an internal communication path L20. The second switch 24 and the third storage medium 26 are connected via an internal communication path L16. The second switch 24 and the fourth storage medium 28 are connected via an internal communication path L17. Parts of the internal communication path L20, the internal communication path L16, and the internal communication path L17 in the second device 20 are an example of a second internal communication path and are communication paths for transmitting and receiving a signal through master-slave communication. In the signal processing system 1, the first processor 12 is a master, and the second processor 22, the second switch 24, the third storage medium 26, and the fourth storage medium 28 are slaves.

The first processor 12 transmits a switch control signal to the first switch 14 via an internal communication path L14 and transmits a switch control signal to the second switch 24 via an internal communication path L15. The internal communication path L15 is connected from the internal communication path of the first device 10 to the second switch 24.

The first switch 14 is connected to the first storage medium 30 via an internal communication path L13a. The internal communication path L13a is connected from the internal communication path of the first device 10 to the first storage medium 30. The second switch 24 is connected to the first storage medium 30 via an internal communication path L13b. The internal communication path L13b is connected from the internal communication path of the second device 20 to the first storage medium 30.

The first switch 14 and the second switch 24 are connected to the third storage medium 26 via an internal communication path L16. The internal communication path L16 is formed to connect the internal communication path of the first device 10 and the internal communication path of the second device 20 to the third storage medium 26. The first switch 14 and the second switch 24 are connected to the fourth storage medium 28 via an internal communication path L17. The internal communication path L17 is formed to connect the internal communication path of the first device 10 and the internal communication path of the second device 20 to the fourth storage medium 28.

A communication path of the internal communication path L16 included in the first device 10 is a first internal communication path included in the first device 10, and a communication path of the internal communication path L16 included in the second device 20 is a second internal communication path included in the second device 20. A communication path of the internal communication path L17 included in the first device 10 is the first internal communication path included in the first device 10, and a communication path of the internal communication path L17 included in the second device 20 is the second internal communication path included in the second device 20.

The first storage medium 30 is, for example, a static random access memory (SRAM), but the present invention is not limited thereto, and the first storage medium 30 may be a flash ROM. The first storage medium 30 is connected to the first internal communication path and the second internal communication path, stores a control signal input via the first internal communication path, and outputs the stored control signal via the second internal communication path.

FIG. 2 is a flowchart illustrating an example of an operation flow of the first processor 12 according to the embodiment.

The first processor 12 determines whether a request has been received from the external device 40 (Step S10). When a request has not been received from the external device 40 (Step S10: NO), the first processor 12 maintains a standby state. When a request (which includes receiving of a control signal) has been received from the external device 40 (S10: YES), the first processor 12 establishes master-slave communication with the first switch 14, the second storage medium 16, the first storage medium 30, the second processor 22, the second switch 24, the third storage medium 26, and the fourth storage medium 28 (Step S12). Accordingly, the first processor 12 serves as a master device, and the first switch 14, the second storage medium 16, the first storage medium 30, the second processor 22, the second switch 24, the third storage medium 26, and the fourth storage medium 28 serve as slave devices.

In response to the request, the first processor 12 performs switch switching control of the first switch 14 and the second switch 24 (Step S14), control of the second processor 22 (Step S16), and transmission control of data via the first storage medium 30 and the like (Step S18). The first processor 12 determines whether a process based on the request has been completed (Step S20), repeats the processes of Steps S14 to S18 when the process has not been completed (Step S20: NO), and ends the operation flow of the flowchart when the process has been completed (Step S20: YES).

The first processor 12 and the second processor 22 may perform communication via the first internal communication path and the second internal communication path when an amount of information of the control signal is greater than a threshold value and perform direct communication via the bidirectional serial communication path L2 when the amount of information of the control signal is not greater than the threshold value. The threshold value is determined on the basis of a capacity of the control signal output from the external device 40 or a communication speed of the bidirectional serial communication path L2. For example, when a capacity of the control signal output from the external device 40 is great, a communication speed of the bidirectional serial communication path L2 is lower than that of the serial communication path L1, and a time of a predetermined value or more is calculated to be required for serial communication via the bidirectional serial communication path L2, the control signal is determined to be a control signal greater than the threshold value.

In addition, the first processor 12 may select whether to transmit a signal output from the external device 40 to the control target device 50 via the bidirectional serial communication path L2 or via the first internal communication path and the second internal communication path. The external device 40 adds, for example, header information indicating whether to transmit a signal to the control target device 50 via the bidirectional serial communication path L2 or via the first internal communication path and the second internal communication path to a signal toward the control target device 50. Accordingly, the first processor 12 can select whether to output a signal toward the control target device 50 to the first switch 14 side or the bidirectional serial communication path L2 side with reference to the header information.

FIG. 3 is a diagram illustrating an example of a circuit configuration of the signal processing system 1 according to the embodiment. The first switch 14 includes a contact connected to the second storage medium 16, a contact connected to the third storage medium 26, a contact connected to the fourth storage medium 28, and a contact connected to the first storage medium 30. The first switch 14 connects the first processor 12 to one contact on the basis of a switch control signal output from the first processor 12. The second switch 24 includes a contact connected to the first storage medium 30, a contact connected to the fourth storage medium 28, and a contact connected to the third storage medium 26. The second switch 24 connects the second processor 22 to one contact on the basis of a switch control signal output from the first processor 12.

FIG. 4 is a diagram illustrating an example of a circuit configuration in which the first switch 14 and the second storage medium 16 are connected in the signal processing system according to the embodiment. The first processor 12 connects the first switch 14 and the second storage medium 16 and connects the second switch 24 and the third storage medium 26. For example, the first processor 12 can read a program stored in the second storage medium 16 and operate. For example, the second processor 22 can read a program stored in the third storage medium 26 and operate.

FIG. 5 is a sequence diagram illustrating an example of a process of transmitting a control signal from the external device 40 to the control target device 50 that is performed by the signal processing system 1 according to the embodiment.

The external device 40 transmits writing start information S30 to the first processor 12 via the serial communication path L1. The writing start information S30 is a request for writing a signal from the external device 40 to the first storage medium 30. The first processor 12 outputs a switch control signal for connection to the first storage medium 30 side to the first switch 14 in response to inputting of the writing start information S30. Accordingly, the first switch 14 is connected to the first storage medium 30. FIG. 6 is a diagram illustrating an example of a circuit configuration in which the first switch 14 and the first storage medium 30 are connected in the signal processing system 1 according to the embodiment.

The external device 40 outputs a control signal S34 to the first processor 12 via the serial communication path L1, and the first processor 12 outputs the control signal S34 to the first storage medium 30 via the first switch 14. The control signal is written to the first storage medium 30 in the embodiment, but the present invention is not limited thereto, and this embodiment can also be applied to other information of a large capacity.

The first processor 12 receives writing completion information S36 from the external device 40 via the serial communication path L1. The first processor 12 outputs a switch control signal S38 for connection to the second storage medium 16 side to the first switch 14 in response to inputting of the writing completion information S36, Accordingly, the first switch 14 is connected to the second storage medium 16. FIG. 7 is a diagram illustrating an example of a circuit configuration in which the first switch 14 and the second storage medium 16 are connected in the signal processing system 1 according to the embodiment.

The first processor 12 outputs reading reparation information S40 to the second processor 22 via the bidirectional serial communication path L2. The second processor 22 temporarily stops reading from the third storage medium 26 and enters a standby state in response to inputting of the reading preparation information S40 from the first processor 12.

The first processor 12 outputs a switch control signal S42 for connection to the first storage medium 30 side to the second switch 24. Accordingly, the second switch 24 is connected to the first storage medium 30. FIG. 7 is a diagram illustrating an example of a circuit configuration in which the second switch 24 and the first storage medium 30 are connected in the signal processing system 1 according to the embodiment. The first processor 12 outputs reading start information S44 to the second processor 22 via the bidirectional serial communication path L2. The second processor 22 starts reading from the first storage medium 30 in response to inputting of the reading start information S44 from the first processor 12, acquires data S46 from the external device 40 which is stored in the first storage medium 30, and outputs a control signal S48 to the control target device 50 via the serial communication path L3.

FIG. 8 is a sequence diagram illustrating an example of a process of causing the external device 40 to read a signal stored in the first storage medium 30 that is performed by the signal processing system 1 according to the embodiment.

The external device 40 transmits reading start information S50 to the first processor 12 via the serial communication path L1. The reading start information S50 is a request for reading a signal stored in the first storage medium 30 to the external device 40. The first processor 12 outputs reading start information S52 to the second processor 22 via the bidirectional serial communication path L2 in response to inputting of the reading start information S50. The second processor 22 temporarily stops reading from the third storage medium 26 and enters a standby state in response to inputting of the reading start information S52 from the first processor 12.

The first processor 12 outputs a switch control signal S54 for connection to the first storage medium 30 side to the second switch 24. Accordingly, the second switch 24 is connected to the first storage medium 30. The first processor 12 outputs writing start information S56 toward the first storage medium 30 to the second processor 22 via the bidirectional serial communication path L2.

The second processor 22 acquires reading data S58 from the control target device 50 via the serial communication path L3 in response to inputting of the writing start information S56 from the first processor 12 and writes the acquired data as writing data S60 to the first storage medium 30. The second processor 22 outputs writing completion information S62 to the first processor 12 via the bidirectional serial communication path L2 after having completed writing of the writing data S60.

The first processor 12 outputs a switch control signal S64 for connection to the third storage medium 26 side to the second switch 24 in response to inputting of the writing completion information S62 from the second processor 22. Accordingly, the second switch 24 is connected to the third storage medium 26. The first processor 12 outputs writing end information S66 to the second processor 22 via the bidirectional serial communication path L2. The second processor 22 restarts reading from the third storage medium 26 in response to inputting of the writing end information S66 from the first processor 12.

The first processor 12 outputs a switch control signal S68 for connection to the first storage medium 30 side to the first switch 14. Accordingly, the first switch 14 is connected to the first storage medium 30. The first processor 12 outputs reading permission information S70 to the external device 40 via the serial communication path L1, reads reading data S72 from the first storage medium 30, and outputs data S74 from the control target device 50 stored in the first storage medium 30 to the external device 40. The first processor 12 outputs reading completion information S76 to the external device 40 when the data S72 read from the first storage medium 30 departs from a reading range.

FIG. 9 is a sequence diagram illustrating an example of a process of rewriting a program stored in the fourth storage medium 28 that is performed by the signal processing system 1 according to the embodiment.

The external device 40 transmits writing start information S80 to the fourth storage medium 28 to the first processor 12 via the serial communication path L1. The first processor 12 outputs a switch control signal S82 for connection to the fourth storage medium 28 side to the first switch 14 in response to inputting of the writing start information S80. Accordingly, the first switch 14 is connected to the fourth storage medium 28. FIG. 10 is a diagram illustrating an example of a circuit configuration in which the first switch 14 and the fourth storage medium 28 are connected in the signal processing system 1 according to the embodiment.

Then, the external device 40 outputs a program signal S84 to the first processor 12 via the serial communication path L1, and the first processor 12 outputs the program signal S84 to the fourth storage medium 28 via the first switch 14. Accordingly, the program signal S84 is written to the fourth storage medium 28.

Then, the external device 40 outputs writing completion information S86 to the first processor 12 via the serial communication path L1. The first processor 12 outputs a switch control signal S88 for connection to the second storage medium 16 side to the first switch 14 in response to inputting of the writing completion information S86 (FIG. 11). Accordingly, the first switch 14 is connected to the second storage medium 16. Then, the first processor 12 outputs medium switching preparation information S90 to the second processor 22 via the bidirectional serial communication path L2. The second processor 22 temporarily stops reading from the third storage medium 26 and enters a standby state in response to inputting of the medium switch preparation information S90.

The first processor 12 outputs a switch control signal S92 for connection to the fourth storage medium 28 side to the second switch 24. Accordingly, the second switch 24 is connected to the fourth storage medium 28. FIG. 11 is a diagram illustrating an example of a circuit configuration in which the second switch 24 and the fourth storage medium 28 are connected in the signal processing system 1 according to the embodiment. The first processor 12 outputs reset start information S94 to the second processor 22 via the bidirectional serial communication path L2. The second processor 22 is reset in response to inputting of the reset start information S94. Accordingly, the second processor 22 stops reading from the third storage medium 26, reads a program stored in the fourth storage medium 28 via the second switch 24, and operates.

FIG. 12 is a sequence diagram illustrating an example of a process of rewriting a program stored in the third storage medium 26 that is performed by the signal processing system 1 according to the embodiment.

When the second processor 22 is operating in accordance with a program stored in the fourth storage medium 28, the external device 40 transmits writing start information S100 to the third storage medium 26 to the first processor 12 via the serial communication path L1. The first processor 12 outputs a switch control signal S102 for connection to the third storage medium 26 side to the first switch 14 in response to inputting of the writing start information S100. Accordingly, the first switch 14 is connected to the third storage medium 26. FIG. 13 is a diagram illustrating an example of a circuit configuration in which the first switch 14 and the third storage medium 26 are connected in the signal processing system 1 according to the embodiment.

Then, the external device 40 outputs a program signal S104 to the first processor 12 via the serial communication path L1, and the first processor 12 outputs the program signal S104 to the third storage medium 26 via the first switch 14. Accordingly, the program signal S104 is written to the third storage medium 26.

Then, the external device 40 outputs writing completion information S106 to the first processor 12 via the serial communication path L1. The first processor 12 outputs a switch control signal S108 for connection to the second storage medium 16 side to the first switch 14 in response to inputting of the writing completion information S106. Accordingly, the first switch 14 is connected to the second storage medium 16 (FIG. 4). Then, the first processor 12 outputs medium switching preparation information S110 to the second processor 22 via the bidirectional serial communication path L2. The second processor 22 temporarily stops reading from the fourth storage medium 28 and enters a standby state in response to inputting of the medium switch preparation information S110.

The first processor 12 outputs a switch control signal S112 for connection to the third storage medium 26 side to the second switch 24. Accordingly, the second switch 24 is connected to the third storage medium 26 (FIG. 4). The first processor 12 outputs reset start information S114 to the second processor 22 via the bidirectional serial communication path L2. The second processor 22 is reset in response to inputting of the reset start information S114. Accordingly, the second processor 22 reads a program stored in the third storage medium 26 via the second switch 24, and operates.

As described above, the signal processing system 1 according to the embodiment includes the first device 10, the second device 20 connected to the first device 10 via the serial communication path L1 and configured to control a control target device 50, and the first storage medium 30 connected to the first device 10 and the second device 20. The first device 10 includes the first processor 12 configured to output a control signal and the second storage medium 16 connected to the first processor 12 via the first internal communication path (L11, L12). The second device 20 includes the second processor 22 configured to control the control target device 50 on the basis of a control signal and the third storage medium 26 connected to the second processor 22 via the second internal communication path (L20, L16). The first storage medium 30 is connected to the first internal communication path (L11, L13a) and the second internal communication path (L20, L13b), stores the control signal input via the first internal communication path, and outputs the stored control signal via the second internal communication path. With this signal processing system 1, it is possible to enable rapid transmission of a signal with respect to the control target device 50, for example, using a faster internal communication path than the bidirectional serial communication path L2.

In the signal processing system 1, the second device 20 includes the fourth storage medium 28 connected to the second internal communication path, and the first processor 12 performs rewriting of a program to the fourth storage medium 28 on the basis of a program signal for operation of the second processor 22 output from the external device 40. The second processor 22 operates using a program stored in the third storage medium 26 and reads a program from the fourth storage medium 28 in response to completion of rewriting of the program. Accordingly, with the signal processing system 1, it is possible to shorten a period for switching a program. As a result, with the signal processing system 1, it is possible to shorten a period in which a control period for the control target device 50 is interrupted by shortening a period in which the second processor 22 stops its operation. Specifically, with the signal processing system 1, it is possible to curb a period in which the display device is not controlled by the control target device 50 and display thereof includes a defect.

In the signal processing system 1, the first device 10 includes the first switch 14 connected to the first processor 12, the first storage medium 30, the second storage medium 16, the third storage medium 26, and the fourth storage medium 28, and the second device 20 includes the second switch 24 connected to the second processor 22, the first storage medium 30, the third storage medium 26, and the fourth storage medium 28. When a control signal is received from the external device 40, the first processor 12 establishes master-slave communication with the second processor 22, the first switch 14, the second switch 24, the first storage medium 30, the second storage medium 16, and the third storage medium 26. Accordingly, the first processor 12 serves as a master device, and the second processor 22, the first switch 14, the second switch 24, the first storage medium 30, the second storage medium 16, and the third storage medium 26 serve as slave devices. As a result, since the first processor 12 performs master-slave communication with the second processor 22, the first storage medium 30, the first switch 14, the second storage medium 16, the third storage medium 26, and the fourth storage medium 28, it is possible to realize fast communication.

In the signal processing system 1, when the control signal is input from the external device 40, the first processor 12 controls the first switch 14 such that a control signal input from the first processor 12 is output to the first storage medium 30 and controls the second switch 24 such that the control signal stored in the first storage medium 30 is received and output to the second processor 22. Accordingly, the signal processing system 1 can rapidly transmit the control signal.

In the signal processing system 1, when a program signal is input from the external device 40, the first processor 12 controls the second switch 24 such that the program signal stored in the third storage medium 26 is output to the second processor 22 and controls the first switch 14 such that the program signal input from the first processor 12 is output to the fourth storage medium 28. In response to completion of writing of the program signal input from the external device 40, the signal processing system 1 controls the second switch 24 such that the program signal stored in the fourth storage medium 28 is output to the second processor 22 and causes the second processor 22 to operate the program signal stored in the fourth storage medium 28 by resetting the second processor 22. Accordingly, with the signal processing system 1, it is possible to switch a program used by the second processor 22 without stopping the operation of the second processor 11.

FIG. 14 is a block diagram illustrating a modified example of the signal processing system 1 according to the embodiment. The signal processing system 1 is separate from the control target device 50, but the signal processing system 1 according to a modified example is incorporated into a control target device 100. The control target device 100 includes, for example, a signal processing system 1 and an operating unit 110 that is controlled by the second device 20. For example, the operating unit 110 acquires a control signal output from the external device 40 via the signal processing system 1 and operates on the basis of the control signal. The operating unit 110 outputs information indicating a current control state to the signal processing system 1. The control target device 100 is, for example, a display device, and the operating unit 110 performs display based on the control signal.

While embodiments and modified examples have been described above, the present invention is not limited thereto. For example, one of the embodiments and the modified examples, a part of the embodiments, or a part of the modified examples may be combined with another or more of the embodiments or another or more of the modified examples to realize an aspect of the present invention.

### REFERENCE SIGNS LIST

1 Signal processing system

10 First device

12 First processor

14 First switch

16 Second storage medium

20 Second device

22 Second processor

24 Second switch

26 Third storage medium

28 Fourth storage medium

30 First storage medium

40 External device

50 Control target device

L1 Serial communication path (first communication path)

L2 Bidirectional serial communication path

L3 Serial communication path

L11 Internal communication path (first internal communication path)

L12 Internal communication path (first internal communication path)

L13a Internal communication path (first internal communication path)

L13b Internal communication path (second internal communication path)

L14, L15 Internal communication path

L16, L17 Internal communication path

L20 Internal communication path (second internal communication path)

100 Control target device

110 Operating unit

What is claimed is:

1. A signal processing system comprising:
a first device configured to receive a control signal from an external device;
a second device connected to the first device and configured to control a control target device; and
a first storage medium connected to the first device and to the second device,
wherein the first device comprises:
a first processor configured to output the control signal to the second device; and
a second storage medium connected to the first processor via a first internal communication path,
wherein the second device comprises:
a second processor configured to control the control target device on the basis of the control signal; and
a third storage medium connected to the second processor via a second internal communication path, and
wherein the first storage medium is connected to the first internal communication path and the second internal communication path,
wherein the first storage medium stores the control signal, which has been input via the first internal communication path, and
wherein the first storage medium allows the control signal stored to be output via the second internal communication path.

2. The signal processing system according to claim 1, wherein the second device comprises:
a fourth storage medium connected to the second internal communication path,
wherein the first processor is configured to rewrite a first program in the fourth storage medium on the basis of a program signal for causing the second processor to operate, and
wherein the second processor is operable using a second program stored in the third storage medium and reads the first program rewritten by the first processor from the fourth storage medium in response to completion of rewriting the first program by the first processor.

3. The signal processing system according to claim 2,
wherein the first device comprises:
a first switch connected to the first processor, the first storage medium, the second storage medium, the third storage medium, and the fourth storage medium,
wherein the second device comprises:
a second switch connected to the second processor, the first storage medium, the third storage medium, and the fourth storage medium,
wherein the first processor is configured to establish, upon recipt of the control signal from the external device, a master-slave communication among the second processor, the first switch, the second switch, the first storage medium, the second storage medium, the third storage medium, and the fourth storage medium,
wherein the first processor serves as a master device, and
wherein the second processor, the first switch, the second switch, the first storage medium, the second storage medium, the third storage medium, and the fourth storage medium serve as slave devices.

4. The signal processing system according to claim 3,
wherein the first processor is configured to control, for outputting the control signal, the first switch to cause the control signal that has been input from the first processor to output to the first storage medium and control the second switch to cause the control signal stored in the first storage medium to be output to the second processor.

5. The signal processing system according to claim 3,
wherein the first processor is configured to control, for outputting the program signal, the second switch to cause the program signal stored in the third storage medium to be output to the second processor and the first switch to cause the program signal which has been input from the first processor to be output to the fourth storage medium, and
wherein the first processor is configured to control, for outputting the program signal, the second switch to cause the program signal stored in the fourth storage medium to be output to the second processor in response to completion of writing of the program signal and to cause the second processor to operate using the program signal stored in the fourth storage medium by resetting the second processor.

6. The signal processing system according to claim 1, wherein the first processor and the second processor are connected to each other via a bidirectional serial communication path for enabling bidirectional serial communication.

7. The signal processing system according to claim 6,
wherein the first processor and the second processor are configured to transmit signals having greater amounts of information in excess of a threshold value via the first internal communication path and the second internal communication path, and
wherein the first processor and the second processor are configured to transmit signals having smaller amounts of information less than the threshold value via the bidirectional serial communication path.

8. The signal processing system according to claim 1, wherein the control target device is a display device.

9. A control target device comprising:
a first device configured to receive a control signal from an external device;
a second device connected to the first device;
a first storage medium connected to the first device and the second device; and
an operating unit controlled by the second device,
wherein the first device comprises:
a first processor configured to output a control signal to the second device; and
a second storage medium connected to the first processor via a first internal communication path,
wherein the second device comprises:
a second processor configured to control the operating unit on the basis of the control signal; and
a third storage medium connected to the second processor via a second internal communication path, and
wherein the first storage medium is connected to the first internal communication path and the second internal communication path, and
wherein the first storage medium stores the control signal which has been input via the first internal communication path, and outputs the control signal stored via the second internal communication path.

10. A signal processing method in a signal processing system which comprises: a first device configured to receive a control signal from an external device; a second device connected to the first device and configured to control a control target device; a first storage medium connected to the first device and the second device; and a bidirectional serial communication path configured to enable the first device and the second device to perform bidirectional serial communication, the signal processing method comprising:
determining whether an amount of information of the control signal is greater than a threshold value;
causing a first processor of the first device to output the control signal to the first storage medium via a first internal communication path of the first device when the amount of information of the control signal is greater than the threshold value;
causing a second processor of the second device to input the control signal from the first storage medium via a second internal communication path of the second device; and
causing the second processor to output the control signal to the control target device.
